(19) United States
(12) Patent Application Publication
(10) Pub. No.: US 2009/0070150 A1
(43) Pub. Date: Mar. 12, 2009

(54) Methods and Systems for Managing the Risks of Patent Coverage

(76) Inventors: James E. MALACKOWSKI, Chicago, IL (US); Andrew W. CARTER, Chicago, IL (US); Adam CLIFFORD, Chicago, IL (US); Richard CONROY, Chicago, IL (US); Michael O. HILL, Chicago, IL (US); Michael J. LASINSKI, Chicago, IL (US)

Correspondence Address: Charles C. Valauskas;VALAUSKAS & PINE LLC, Suite 1825, 150 North Wacker Drive, Chicago, IL, 60606, US

(21) Appl. No.: 11/744,699

(22) Filed: May 4, 2007

Related U.S. Application Data
(60) Provisional application No. 60/746,388, filed on May 4, 2006.

(51) Int. Cl. G06Q 40/00

(52) U.S. Cl. 705/4; 705/1

(57) ABSTRACT

Presented herein are methods and systems for managing an entity's risks of patent coverage. More specifically, the present invention is directed to methods and system for insuring an entity against damage awards in patent litigation. The presented methods and systems allow a manufacturer to minimize their exposure to damage awards in patent litigation by conducting pre-emptive analyses and properly allocating funds for royalty payments and/or damage awards. An insurance market is also established to insure the manufacturer against excessive damage awards.

### PRIORITY CLAIM

This application claims the benefit of U.S. Provisional Application No. 60/746,388, filed May 4, 2006, entitled “Method of Managing the Risks of Patent Coverage”.

### BACKGROUND OF THE INVENTION

1. Field of the Invention

The present invention relates to methods and systems for managing an entity's risks of patent coverage. More specifically, the present invention is directed to methods and systems for managing and transferring the risk of liabilities arising from patent infringement litigation.

2. Background

In the current marketplace, many businesses are exposed to the risk of infringement assertions of third-party patents when launching a new product or service. Such patents may be owned by competitors, individual inventors, or patent licensing and enforcement companies (PLECs). Historically, relevant third-party patents were usually held by competitors, and the risk of infringement claims could often be managed through cross-licensing and credible threats of countersuits. Today, however, because of the increased threat of assertion of patents by individual inventors and PLECs, cross-licensing and threat of countersuit are often insufficient for protecting a business from such assertions. Further, the risk of “royalty stacking,” wherein a business is forced to pay royalties to multiple patent holders, adds to the overall costs and risks of releasing such a product or service. Additionally, judges and juries have had a difficult time reaching a reasonable assessment of the economic benefit of infringed patents resulting in unexpected and excessively large patent infringement damages awards. Currently available risk management products are known to be expensive and offer insufficient coverage limits for many potential consumers. Further, insurers have historically experienced difficulty in efficiently pricing such products, resulting in unacceptably high premiums or loss on the underwriting of policies.

### BRIEF SUMMARY OF THE INVENTION

Presented herein are methods of managing an entity's risks of patent coverage. More specifically, the present invention is directed to systems and methods of managing and transferring the risk of liabilities arising from patent infringement litigation. The presented methods allow an entity to minimize or transfer its exposure to patent infringement litigation liabilities by conducting pre-emptive analyses and properly allocating funds for potential royalty payments, settlement costs, patent infringement damages and/or litigation costs. Also presented herein are insurance systems to facilitate the managing and transferring of the risk of liabilities arising from patent infringement litigation.

Disclosed herein is a method of managing exposure to damages liability to a third-party patent owner. The method comprises the steps of: performing a patent search to identify an infringement relevancy group, wherein the infringement relevancy group includes at least one patent having at least one claim reading on a product; calculating a willing fair royalty for at least one patent in the infringement relevancy group; offering the calculated willing fair royalty to at least one owner of the patent owner group; and underwriting an insurance policy, wherein a premium for the insurance policy is based in part on how many owners from the patent owner group accept the offered willing fair royalty. The insurance policy may provide that an insurer will indemnify an entity for damages liability owed to an owner from the patent owner group, and/or indemnify an entity for damages liability owed to an owner of a patent, wherein the patent is not in the infringement relevancy group. The method may further comprise the step of calculating a total fair royalty for the product based on the infringement relevancy group. The step of calculating a total fair royalty may include estimating an amount of profit from sales of the product. The step of calculating a total fair royalty may include estimating an amount of revenue from sales of the product. The method may further comprise the steps of analyzing whether at least one patent in the infringement relevancy group is valid and obtaining a validity opinion on at least one patent in the infringement relevancy group. The method may further comprise the step of shielding the infringement relevancy group from an entity if the entity may be subject to damages liability to an owner of a patent in the infringement relevancy group.

Also disclosed herein is a method of providing an entity with a way of managing exposure to damages liability. The method comprises: performing an economic analysis to calculate a total maximum royalty for a product, wherein the total maximum royalty is based on an estimated cost and an estimated sale price of the product; and underwriting an insurance policy, wherein a premium of the insurance policy is based in part on the calculated total maximum royalty, and wherein the insurance policy includes a provision providing that at least a portion of any unused premium is returned to the manufacturer upon termination of the insurance policy. The method may further comprise the step of calculating a fair maximum potential liability (FMPL), wherein the FMPL is based on the total maximum royalty and the amount of royalty attributable to the entity's own intellectual property. The premium of the insurance policy may be based in part on the calculated FMPL. The method may further comprise the step of offering the insurance policy to the entity. The method may further comprise the step of indemnifying the entity if the entity is liable for damages liability to a third-party by delivering at least a portion of the premium to the third-party. The method may further comprise the step of returning at least a portion of the premium to the entity.

Further disclosed herein is a system comprising a computer-readable storage medium that stores instructions executable by at least one processing device. The storage medium generally includes, instructions for obtaining a search query, the search query identifying a infringement relevancy group, wherein the infringement relevancy group includes at least one patent having at least one claim reading on a product. The storage medium further includes instructions for determining a total fair royalty and allocating the total fair royalty to determine a willing fair royalty for at least one patent in the infringement relevancy group. The system further comprises a user interface adapted to display an output from the processing device after the processing device has executed at least one of the instructions. The output displayed on the user interface may be the determined willing fair royalty. The user interface may be a webpage. Such a system provides an information point where a patent owner may go to see if a product manufacturer is offering a license to make, use, sell and/or distribute a product covered by a patent owned by the patent owner.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left most digit of a reference number identifies the drawing in which the reference number first appears.

FIG. 1 is a schematic, high-level diagram of one embodiment of the present invention.

FIG. 2 is a flowchart showing an exemplary method of determining a Willing Fair Royalty.

FIG. 3 illustrates an exemplary computer system in which the presented methods may be implemented as computer-readable code.

FIG. 4 is a schematic, high-level diagram of an alternative embodiment of the present invention.

FIG. 5 is a flowchart showing an exemplary method in accordance with an alternative embodiment of the present invention.

### DETAILED DESCRIPTION OF THE INVENTION

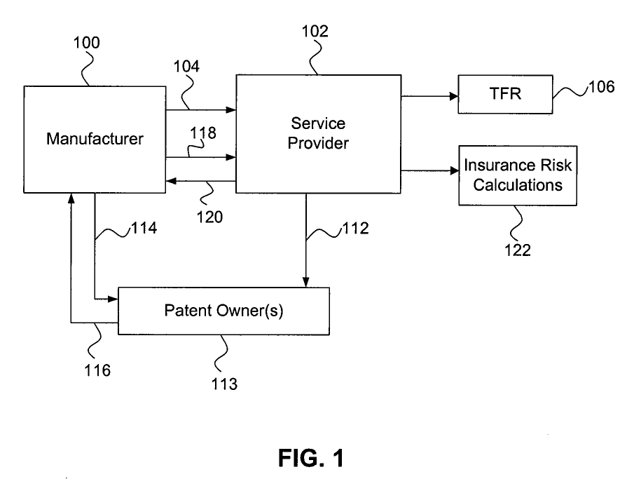

FIG. 1 shows a schematic, high-level diagram of one embodiment of the present invention. As shown in FIG. 1, an entity, in this example a manufacturer 100, presents a new product 104 to a service provider 102. The term “product” is not meant to be limited to a tangible item. For instance, a product may also include a service. In such a case, the “manufacturer” of the service would be an entity which offers the service to customers. Therefore, as used herein, the term “product” is meant to broadly include any article of manufacture, machine, composition, system, computer program product, software, hardware, signal, process, methods of making or using an apparatus, business methods, or services.

Manufacturer 100 engages service provider 102 to manage and/or transfer the risk that one or more third-party patent owners may assert that their patents contain one or more claims covering (i.e., reading on) new product 104. As used herein, claims “covering” the product refers broadly to claims that could reasonably be believed to be infringed by product 104 as a whole, or by some aspect embodied in product 104. For example, where product 104 is an article of manufacture, patent claims may read on the article when a particular component of the article could reasonably be asserted to infringe the claims. Other patent claims may be considered to cover a method of manufacture of the article when the manufacturer employs a process during the manufacture of the item that could reasonably be asserted to infringe the claims. Further, patent claims may be considered to cover the article simply because manufacturer 100 uses an intermediate product in the manufacture of the article that could reasonably be asserted to infringe the claims. Hence, it is possible that a plurality of patents may be considered to cover new product 104.

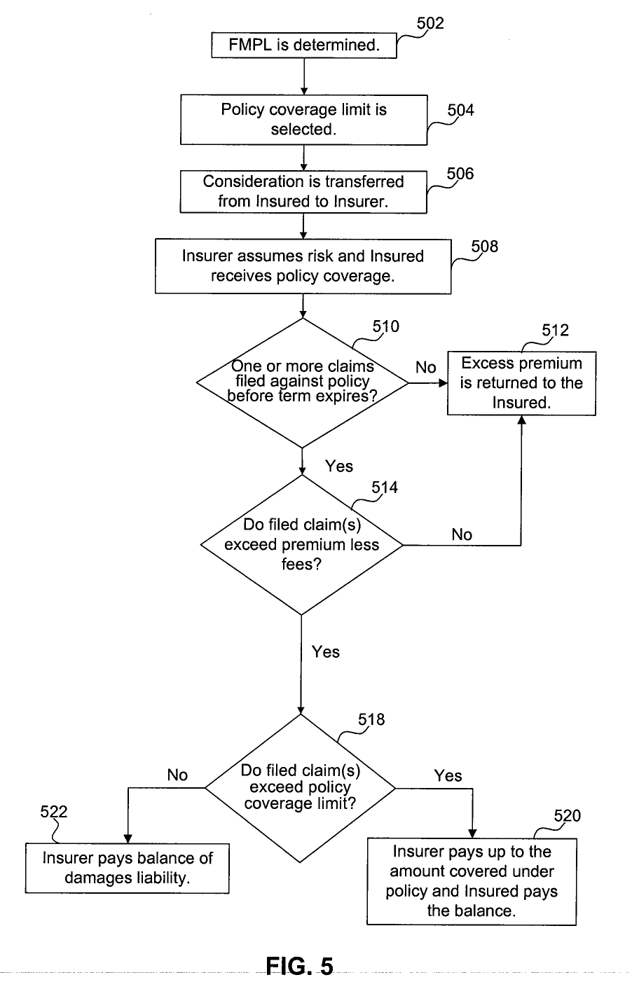

Service provider 102 determines a Total Fair Royalty (TFR) 106 for the product 104. An TFR 106 is an estimation of the percentage of the revenue (or other measurable metric) of a product that should be set aside for royalty payments adequate to fairly compensate patent owners for the use of patents covering the product. In determining TFR 106, service provider 102 can take into account such considerations as how many patents cover the new product, other intellectual property embodied in new product 104, the relative importance of the patents that cover the new product 104, established royalties for comparable patents or products, the expected profitability of new product 104, and the expected revenue of new product 104. According to various embodiments, TFR 106 can also be determined using economic tools. For example, TFR 106 can be based on the fair maximum potential liability, described herein with reference to FIG. 5.

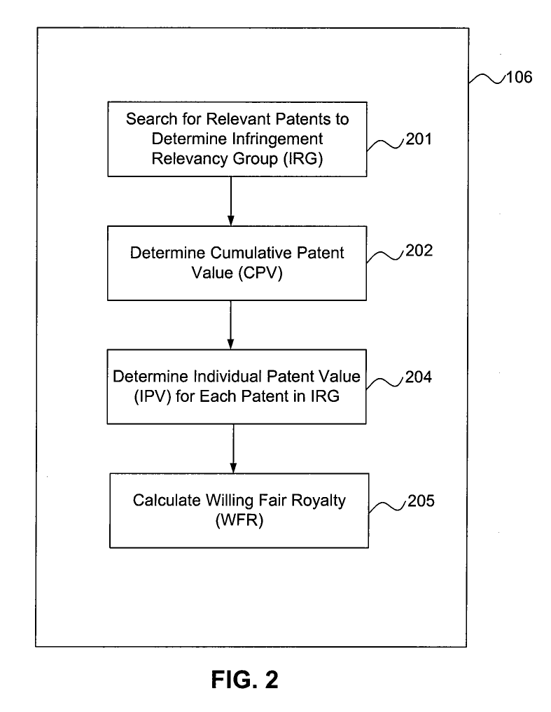

In some embodiments, after making a determination of TFR 106, service provider 102 provides notice 112 to patent owner(s) 113 who have the right to assert patent(s) covering new product 104. Notice 112 may be provided in a variety of ways, and, according to various embodiments, can be given either publicly or privately. For example, service provider 102 may contact patent owner(s) 113 by certified mail, or by making a public announcement via the internet or a publication such as the WALL STREET JOURNAL® newspaper. Public notice 112 thereby notifies patent owner(s) 113 of manufacturer's 100 willingness to pay a Willing Fair Royalty (WFR) 114 for a license 116 to make, have made, use, sell, and/or distribute new product 104. WFR 114 will typically be different from TFR 106. TFR 106 is the total amount allocated for royalty payments to all patent owners 113 having patents covering the new product 104. WFR 114, on the other hand, is an amount (typically a percentage of TFR 106) offered to a particular patent owner in exchange for a license. In the context of rights granted to manufacturer 100, a license 116 can be embodied as a non-assertion agreement, a covenant not to sue, and other legally binding instruments which will be apparent to one of skill in the art. Methods for determining WFR 114 are described herein with reference to FIG. 2.

If all relevant patent owner(s) 113 accept the offer for WFR 114 in exchange for a license 116, then manufacturer 100 can comfortably proceed with launching new product 104. If, on the other hand, not all relevant patent owner(s) 113 accept the terms of the offer for WFR 114, then the WFR 114 is paid to the accepting patent owner(s) 113, and the manufacturer 100 pays all or some of the unaccepted WFR 114 (in some cases the balance of TFR 106) to the service provider 102 as part of an insurance premium payment 118 against future patent infringement claims. (Insurance premium payment 118 will typically comprise some amount paid that is “pure” premium to protect against additional risks such as those from unaccepted licensing offers, unidentified patents and excessive awards. Insurance premium payment 118 may also include some amount which is paid to service provider 102 as a service fee.)

In return for insurance premium payment 118, and in accordance with insurance risk calculations 122, service provider 102 may provide manufacturer 100 with an insurance policy 120 to cover all, or part of, any damage awards granted in later patent infringement suits. In other embodiments, the insurance policy can also cover other expenses or liabilities related to patent infringement litigations (either actual or threatened), for example, settlement payments, attorney's fees or court costs.

In performing insurance risk calculations 122, service provider 102 can consider the economic risks related to potential liability exposure from patent litigation and such factors as: (i) the likelihood that the identified patents would withstand an invalidity challenge; (ii) the likelihood that new product 104 would actually be found to infringe the identified patents; and (iii) the potential damage awards available to patent owner(s) 113. Additional known insurance risk analysis techniques may be employed in Insurance Risk Calculations 122.

If a sufficient number of patent owner(s) 113 accept WFR 114, then manufacturer 100 has arguably established a market-tested methodology for determining royalty for third-party patents that may cover new product 104. Such an argument may later be used in litigation against any non-accepting patent owner(s) 113 (or any other patent owners not originally identified by service provider 102). If a court ultimately awards damages to any non-accepting patent owner(s) 113, such damages could possibly be limited to a royalty calculated using the same methodology used to calculate WFR. If such damage awards exceed the fair royalty using this established methodology, then the damages (or a portion thereof) may be paid by service provider 102 as the insurer, and not by manufacturer 100 (except to the extent that “co-payments” are required, exclusions apply, or damages awarded exceed the insurance limits set by service provider 102). In an alternative embodiment, a separate entity that is an insurer may assume some or all of the risk assumed by service provider 102. As a result of this indemnification, manufacturer 100 has transferred a portion of the economic risks associated with potential patent infringement litigation. Manufacturer 100 may also effectively plan for the total costs of releasing new product 104, recognize costs associated with revenues in the appropriate period and smooth reported earnings. In the event that manufacturer 100 is not sued for infringement, then service provider 102 (or, in some embodiments, the insurer) may keep the balance of insurance premium payments 118, or may alternatively return some portion of the insurance premium payments 118.

As described, service provider 102 determines a TFR 106, provides notice 112 to patent owner(s) 113, conducts insurance risk calculations 122, and provides manufacturer 100 with insurance 120 in return for insurance premium payments 118. In alternative embodiments, service provider 102 may perform only one of, or any combination of, the listed services. For example, service provider 102 may simply serve as an intermediary between an insurance company and manufacturer 100, provide the service determining TFR 106, and/or provide notice 112. Alternatively, service provider 102 may hire outside consultants, such as law firms or consulting firms, to determine TFR 106. Further, in some embodiments, manufacturer 100 may itself provide notice 112 to patent owner(s) 113. In such alternative embodiments, service provider 102 effectively acts as a manager of the individual steps and associated transactions.

FIG. 2 is a flowchart showing an exemplary method of determining WFR 114. It should be noted that the steps shown in FIG. 2 are shown for exemplary purposes only. Additional or alternative calculations and analysis may be performed without departing from the scope of the present method. Further, WFR 114 may be determined by any entity such as service provider 102 alone, service provider 102 in conjunction with a third-party consultant or law firm, or a third-party consultant or law firm alone.

As shown in FIG. 2, in step 201, a patent search is conducted to identify an Infringement Relevancy Group. An Infringement Relevancy Group (IRG) is a set of one or more patents that cover the new product 104. Known search and infringement analysis techniques can be used to identify the IRG. In some embodiments, the owners of the patents in the IRG are also identified.

The IRG may be revealed to manufacturer 100, or may be shielded from manufacturer 100. Shielding the IRG from manufacturer 100 may protect manufacturer 100 from later claims of willful infringement (and hence may reduce the risk of enhanced or treble damages under 35 U.S.C. § 284).

In step 202, a Cumulative Patent Value (CPV) is determined. The CPV is a quantified expression of the value and/or strength of the patents in the IRG, and may be expressed in monetary units or other units of measure. The CPV may be determined based on various known patent valuation techniques and calculations. For example, the CPV can based on such factors for each patent as: (i) the likelihood that the patent will withstand an invalidity challenge; (ii) the likelihood that the new product will be found to infringe the patent; (iii) the cost of redesigning the product to avoid infringement; and (iv) the potential damage awards stemming from an infringement suit. In another embodiment, CPV can be determined using objective analytic tools. For example, Ocean Tomo Patent Ratings, LLC, of Newport Beach, Calif., produces an Ocean Tomo Patent Maintenance Value (OTMV), which is an assessed patent value based on characteristics, metrics, and claim breadth of a patent. Ocean Tomo Patent Ratings, LLC, also has an alternative metric known as Intellectual Property Quotient (IPQ™). IPQ is a score gauging and comparing patent quality/value based on the cumulative characteristics of the patents and the statistical likelihood that a patent will produce economic returns. CPV can be based on OTMV, IPQ, other metrics available from a variety of alternate providers, or other alternative analytical methodologies. Methods and systems for rating/valuing intangible assets, such as patents, are described in U.S. Pat. No. 6,556,992, U.S. Patent Application Publication No. 2004/0010393, and U.S. Patent Application Publication No. 2004/0220842, the entire disclosures of which are hereby incorporated by reference in their entirety.

In step 204, an individual patent value (IPV) is determined for each patent in the IRG. The IPV is generally expressed in the same unit of measure as the CPV. The IPV may be determined by various analysis techniques, the easiest of which is simply allocating the total CPV equally among the patents in the IRG. In another embodiment, CPV is divided among the patents in the IRG based on the comparative value, relative importance and/or strength of each patent.

It will be appreciated that steps 202 and 204 can be performed in either order according to various embodiments. In one embodiment, for example, IPV for each patent can be determined directly based on subjective or objective analysis of the patents in the IRG, and CPV can be determined by summing the determined IPVs.

In step 205, the WFR 114 for each patent (or patent owner) is determined. WFR 114 can be determined for a particular patent, for example, based on the relationship between the IPV for that patent and the CPV. Thus TFR 106 can be allocated among the owners of patents in the IRG based on the relative IPVs of their patents. Other techniques for determining TFR 106 and WFR 114 will be apparent to one of skill in the art without departing from the scope of the present invention.

Step 201 typically includes a search for potentially relevant patents and an assessment of whether the patents cover (as defined herein) product 104. Published patent applications and foreign patents may also be considered in the patent search of step 201, and as such can be included in the IRG. In some embodiments, published patent applications and foreign patents can also be included in the calculations of steps 202 and 204. According to some embodiments, step 201 can be repeated periodically to detect newly issued or published patents.

In one embodiment, TFR 106 is fixed for the life of the product 104 or some other fixed or conditional period of time, and the identification of a new covering patent or patent application simply results in a reallocation of royalty payments to individual patent owners. In some embodiments, the TFR 106 may change as new covering patents issue, publish, or are identified. In one embodiment, increases to the TFR 106 are offset at least in part by payments from the service provider or the insurer.

Current United States case law in patent matters has focused the determination of a royalty rate for damage awards on either an established royalty or a reasonable royalty based on hypothetical negotiations. Ongoing evolution in relevant case law and proposed legislation reinforce that this fair royalty should reflect a patent's specific contribution of economic value of the product over the prior art and other features and improvement, whether or not patentable, of the product. Accordingly, determining TFR 106 and WFR 114, and ensuing steps, preferably create a recognized methodology to calculate a market-established royalty. Further, the consideration of CPV and IPV(s) relative to TFR provides a recognized methodology for the allocation of the economic benefit to the specific patent. Increased acceptance of the presented method will further strengthen manufacturer's 100 position that WFR 114 is able to calculate a market established royalty. Further, as will be appreciated by those skilled in the relevant art(s) after reading the description herein, in one embodiment, determination of TFR 106 and/or WFR 114 may be periodically repeated (e.g., annually) to identify newly-issued patents, newly-published applications, reissued patents, republished applications, and/or reexamined patents that should be added or deleted to the IRG thereby affecting the ratios of IPVs to CPV and related calculations.

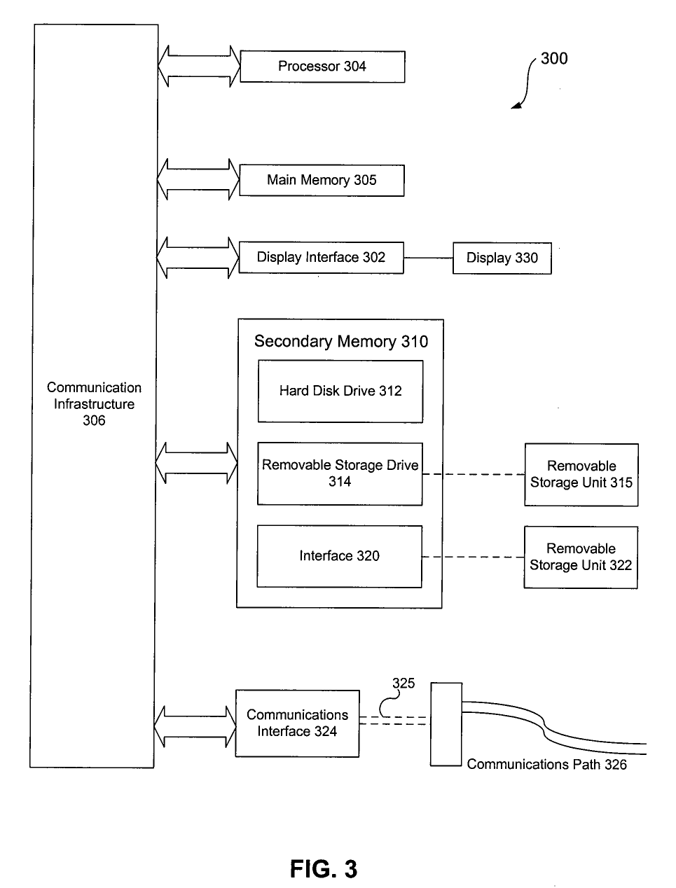

One or more computer systems, or network architectures, may be used to carry out the methods described herein. FIG. 3, for example, illustrates an exemplary computer system 300, in which the methods presented herein may be implemented as computer-readable code. After reading the following description, it will become apparent to a person skilled in the relevant art how to program and implement the invention using available computer systems and/or computer or network architectures.

FIG. 3 illustrates one or more processors, such as processor 304. Processor 304 may be a special purpose or a general purpose digital signal processor. Processor 304 is connected to a communications infrastructure 306 (for example, a bus or network). Computer system 300 may include a display interface 302, also connected to communications infrastructure 306, which forwards graphics, text, and other data from the communication infrastructure 306 (or from a frame buffer not shown) to display unit 330. Computer system 300 also includes a main memory 305, preferably random access memory (RAM), and may also include a secondary memory 310. Secondary memory 310 may include, for example, a hard disk drive 312 and/or a removable storage drive 314, representing a floppy disk drive, a magnetic tape drive, an optical disk drive, etc. Removable storage drive 314 reads from and/or writes to a removable storage unit 315 in a well known manner. Removable storage unit 315, represents a floppy disk, magnetic tape, optical disk, etc., which is read by and written to by removable storage drive 314. As will be appreciated, the removable storage unit 315 includes a computer usable storage medium having stored therein computer software and/or data.

In alternative implementations, secondary memory 310 may include other similar means for allowing computer programs or other instructions to be loaded into computer system 300. Such means may include, for example, a removable storage unit 322 and an interface 320. Examples of such means may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a PCMCIA slot and card, wired or wireless systems, etc. Software and data transferred via communications interface 324 are in the form of signals 325 which may be electronic, electromagnetic, optical or other signals capable of being received by communications interface 324. These signals 325 are provided to communications interface 324 via a communications path 326. Communications path 326 carries signals 325 and may be implemented using wire or cable, fiber optics, a phone line, a cellular phone link, an RF link and other communications channels.

The terms “computer program medium” and “computer usable medium” are used herein to generally refer to media such as removable storage drive 314, a hard disk installed in hard disk drive 312, and signals 325. These computer program products are means for providing software to computer system 300.

Computer programs (also called computer control logic) are stored in main memory 305 and/or secondary memory 310. Computer programs may also be received via communications interface 324. Such computer programs, when executed, enable the computer system 300 to implement the methods presented herein. In particular, the computer programs, when executed, enable the processor 304 to implement the methods presented herein. These methods may be performed automatically, or may be invoked by some form of manual intervention. Accordingly, such computer programs represent controllers of the computer system 300. Where the methods are implemented using software, the software may be stored in a computer program product and loaded into computer system 300 using removable storage drive 314, hard drive 312 or communications interface 324. In implementation, the software and/or computer system 300 described may perform any one of, or any combination of, the steps of any of the methods presented herein.

The invention is also directed to computer products (also called computer program products) comprising software stored on any computer useable medium. Such software, when executed in one or more data processing devices, causes the data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.). It is to be appreciated that the embodiments described herein can be implemented using software, hardware, firmware, or combinations thereof.

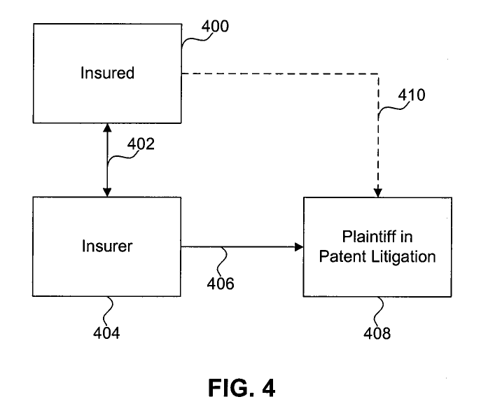

FIG. 4 is a schematic, high-level diagram of an alternative embodiment of the present invention. As shown in FIG. 4, the insured party 400 has a contractual obligation 402 with an insurer 404. The insured party 400 may be a manufacturer as described above. The insurer 404 may be a service provider or insurance company as described above. The contractual obligation 402 is generally an insurance policy. Contractual obligation 402 provides that the insured 400 pays premiums and fees to the insurer 404. In return, the insurer 404 provides a coverage policy to the insured 400. The coverage policy provides that if a plaintiff in a patent infringement suit 408 is awarded damages for which the insured 400 is liable, insurer 404 will pay damages 406 to plaintiff 408. If the damages awarded to plaintiff 408 are in excess of the coverage policy, then the insured 400 pays such excess, as diagramed by arrow 410. In some embodiments, the insurance policy would also cover other expenses or liabilities resulting from patent infringement litigations; for example, settlement payments, attorney's fees or court costs.

FIG. 5 is a flowchart showing an exemplary method in accordance with an alternative embodiment of the present invention, and in accordance with the relationships diagramed in FIG. 4. As shown in FIG. 5, a fair maximum potential liability (FMPL) is determined for a particular product at step 502. To determine FMPL, first a total maximum royalty is determined based on the assumption that all technology embodied in the product would need to be in-licensed by the manufacturer from a 3rd party. The total maximum royalty does not necessarily take into account the value, validity, and/or enforceability of any actual patents. Rather, FMPL is based principally on an economic analysis of the product and/or features of the product. Total maximum royalty is an estimation of the aggregate royalties which a manufacturer would be able to pay and still make sufficient profit to justify producing the product. To determine FMPL, the amount of royalty attributable to the manufacturer's own intellectual property is subtracted from the total maximum royalty. (The “manufacturer's own intellectual property” can include patents and other intellectual property owned by and/or licensed by the manufacture and/or any other technology accessible to which the manufacturer is known to have the rights to freely practice.) To facilitate calculation of the FMPL, the insured may provide information related to historical (if applicable) and projected revenues and profit of the covered product(s). The insured may also provide a summary of licensing information (including licensors, licensees and license terms), technical information (including descriptions of patents and other proprietary technology embodied in the covered products), and market information.

Calculation of the FMPL may be performed utilizing an analytical framework commonly used to establish patent infringement damages under a “reasonable royalty” theory of damages. An analysis is performed to assess a fair and reasonable royalty rate for a single hypothetical license that would grant rights to all technologies embodied in the covered product. This royalty rate would then be adjusted to account for the insured's internally developed or in-licensed technology. The resulting rate would then be used to calculate the FMPL, which could be expressed nominally based on the expected performance of the covered product(s), as a percentage of the covered product's revenue, or as a nominal amount per covered product unit sold.

Alternatively, the calculation of the FMPL may be performed utilizing an analytical framework commonly used to establish patent infringement damages under any patent damages theory; such as for example “lost profits.” For instance, an analysis may be performed to determine how the production and sale of the product will affect the profits of a competitor. The analysis would then assess what damages may potentially be awarded to a competitor under a theory of “lost profits.”

The insured selects a policy coverage limit in step 504. The policy coverage limit can be specified either as a nominal amount or a proportion of the calculated FMPL. The insured may select a policy coverage limit equal to, less than, or greater than the determined FMPL. The insurer may select a policy coverage limit based on the amount of potential future liabilities desired to be protected against at the time of purchasing the insurance policy.

In step 506, the manufacturer provides consideration (i.e. a “premium”) to the insurance company in exchange for the insurance policy. The amount and form of the premium can depend on a variety of factors. In one embodiment, the premium is equal to the policy coverage limit. Some portion of the premium can be assessed as fees due to the insurer. The insurer's fees can be calculated based on the amount of risk being transferred from the insured to the insurer. For example, the fees may be reflective of the risk that the FMPL is accurately calculated. The insurer's fees may be reflective of the policy coverage relative to the portion on the FMPL the insured is willing to pay as premium for the policy. An insured opting to pay premiums equal to FMPL could reasonably expect its potential future liabilities to be fully funded. Should the insured opt to pay premiums less than FMPL, the potential future liabilities would not be fully funded. The insurer may thus assess the appropriate fees based on the amount of policy coverage desired by the insured. This underwriting process may take into consideration data reflective of the insured's historical liabilities which would be covered under the policy, the historical experiences of other companies or industries in general, or such catastrophic event modeling as is known in the art. The likelihood that a patent will be found valid and infringed, either in general or specific to the relevant industry or company, may also be considered in calculating the appropriate fees. Additional fees (for example, administrative or underwriting fees) may also be charged against the premium paid by the insured.

In consideration of the premium received, the insurer, as shown in step 508, assumes the risk that the insured's future damages, up to the policy coverage limit, may exceed the premiums paid.

Referring to step 510, it is determined if any claims have been filed against the policy before the term of the policy expires. The policy generally terminates at the end of the liability exposure period for the covered product(s). For example, the insurance policy can be scheduled to expire at the end of the statutory period of liability (currently, six years from the date of last infringement) of the covered product(s). Alternatively, the insurance policy may be scheduled to expire at a given date after release of the product (i.e. six years from product launch) or upon the occurrence of a given event. In some cases, the insurance policy may be set up such that the insured may cancel the policy at any time.

If no claims have been filed against the policy before expiration, then some portion of the excess premiums are returned to the insured in step 512. The excess premiums are the premiums paid by the insured less all fees due to the insurer. The fees may be managerial fees and/or fees collected to compensate the insurer for taking on the risk that covered liabilities will exceed the premiums received. The fees may be dependent upon the technical field of the product covered.

If claims are filed against the policy before the policy expires, it is determined whether the total claims filed against the policy are in excess of the premiums paid by the insured less fees, as shown in step 514. If the claim(s) do not exceed the premiums paid less fees, some portion of the excess premiums are returned to the insured as shown in step 512. In this scenario, the excess premiums are the premiums paid by the insured less all claims (covered liabilities) against the policy and less all fees due to the insurer. If the claim(s) against the policy exceed the premiums paid less fees, then no premium is returned to the insured.

In step 518, it is determined whether claims (covered liabilities) against the policy exceed the policy coverage limit. If the claims exceed the policy coverage limit, the insurer pays up to the policy coverage limit, and the insured pays the remaining balance of the total liabilities, as shown in step 520. If the claims do not exceed the coverage policy coverage limit, the insurer pays the covered liabilities, as shown in step 522.

The insurance system described in FIG. 5 advantageously allows for manufacturers to cost-effectively transfer risk related to patent infringement litigation, as well as effectively manage their potential future liabilities related to patent infringement litigation. The system aims to smooth earnings volatility resulting from ineffectively managing the future potential liabilities related to patent infringement litigation. The system also may reduce the likelihood of an excessive damages award. For the insurer, the system can be used to effectively assess adequate compensation for the assumption of such risk.

While it is possible for an insured to obtain a single policy to cover all of its products, it is likely that an insured will desire separate policies for different products or product lines.

### HYPOTHETICAL EXAMPLES

Specific examples are presented below for exemplary purposes only. The examples are presented only to further enable one of skill in the art to perform the described methods. The presented examples should not be interpreted to limit the scope of the present invention in any manner.

### Example 1

A Service Provider (SP) is hired by Manufacturer (MR) with respect to MR's product (P). SP searches for relevant patents. SP finds twenty-five third-party patents, owned by twenty-five different patent owners, which could be claimed to cover at least a portion of the features/attributes of P. SP performs an evaluation of the twenty-five third-party patents, assessing their relative value based on a cost-effective analysis of factors including, for each patent in the IRG: (i) likelihood that the patent would withstand an invalidity challenge; (ii) likelihood that P would be found to infringe the patent; and (iii) cost of redesign of P to avoid infringement of any of the claims within the patent. SP determines that the reasonable return to the third-party patent owners would be 25% of operating profits (i.e., EBITDA) for the P—that is, 25% of the operating profits. Operating profits for the P are estimated at $100M per year, so that the aggregate assessed return to third-party patent owners is $25 million per year. MR then agrees to pay this amount annually into a “patent royalty” account maintained and administered by SP. SP then advertises an opportunity for the owners of twenty-five patents in the IRG to seek a share of the P licensing payments. Notice may be provided to known patent owners by certified mail and to others by publication (e.g., a notice placed in the WALL STREET JOURNAL® newspaper).

Assuming that owners of ten of the twenty-five third-party patents elect to participate in the licensing offer, and assuming that each of the “participating” patents is of average value to the P—that is, each accounts for 1/25th of the aggregate value of the IRG—each of the ten participating patent owners licenses its patent to MR for 1/25th of the $25 million annual return to patent inputs, or $1 million annually. Payments to participating patent owners could be set in dollar terms (based on projected operating profits) as in the example, or as percentages of annually determined revenues. MR pays/assigns the remaining 15 “points” (representing $15M or 15% of the operating profit) to an insurer (together with, in some embodiments, an additional risk premium) for indemnification and defense protection against future claims. An insurer, which may or may not be the same entity as SP, will thereafter be able to show, through the above process, an “established rate” of $1M per average patent (scored as above). Further, SP will likely be able to reduce litigation costs/threats through attaching formal Fed. R. Civ. P. Rule 68 Offers of Judgment to any settlement offer it makes. As such, MR protects itself against patent infringement liabilities, and SP is able to make a profit based on insurance risk calculations.

### Example 2

An entity approaches a service provider with details of a new product or service. The service provider (which, in some embodiments, also includes an insurer) conducts a search and analysis of third-party patents that could be claimed to cover the new product or service (or any portions thereof). The service provider calculates a total fair royalty and provides notice to the owners of the potentially covering patents of the entity's willingness to pay licensing fees from the aggregate fair royalty. The entity pays an allocated portion of the fair royalty to any owners of patents potentially covering the new product or service that accept such an offer. The entity pays an insurance premium to an insurance provider. The insurance premium is provided in exchange for insurance coverage in the event that a claim for patent infringement is made against the insured and the insured is found liable for damages to a patent owner who did not accept the original royalty offer or who was identified only after the original royalty offer was made.

### CONCLUSION

While various embodiments of the presented method have been described, it should be understood that they have been presented by way of example, and not limitation. It will be apparent to a person skilled in the relevant art that various alternatives may be incorporated within the presented method without departing from the spirit and scope of the invention. Thus the present invention should not be limited by any of the above-described exemplary embodiments. Further, the purpose of the foregoing Abstract and Summary of the Invention Sections are to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract and Summary of the Invention Sections are not intended to be limiting as to the scope of the present invention in any way.

What is claimed is:

1. A method for managing exposure to damages liability for patent infringement by a product, comprising:
performing a patent search to identify an infringement relevancy group, wherein the infringement relevancy group includes at least a first patent, the first patent having at least one claim covering the product;
determining a total fair royalty for the product;
allocating the total fair royalty among the patents in the infringement relevancy group to determine a willing fair royalty for the first patent; and
offering the determined willing fair royalty to an owner of the first patent.

2. The method of claim 1, further comprising:
receiving a premium for a patent infringement damages insurance policy, wherein the premium for the patent infringement damages insurance policy is based at least in part on whether the owner of the first patent accepts the offered willing fair royalty.

3. The method of claim 2, wherein the patent damages insurance policy indemnifies patent infringement damages liability owed to the owner of the first patent.

4. The method of claim 2, wherein the patent damages insurance policy indemnifies patent infringement damages liability owed to an owner of a patent not in the infringement relevancy group.

5. The method of claim 1, wherein the step of determining a total fair royalty for the product comprises estimating profits from sales of the product.

6. The method of claim 1, wherein the step of determining a total fair royalty for the product comprises estimating revenues from sales of the product.

7. The method of claim 1, further comprising:
assessing the validity of the first patent.

8. The method of claim 1, further comprising:
requesting the determined total fair royalty from a manufacturer of the product, wherein said request does not identify the patents of the infringement relevancy group.

9. A method for managing exposure to damages liability for patent infringement by a product, comprising:
performing a patent search to identify an infringement relevancy group, wherein the infringement relevancy group includes at least a first patent, the first patent having at least one claim covering the product;
determining a first willing fair royalty for the first patent;
offering the first willing fair royalty to a first owner of the first patent; and
if the first owner does not accept the offer of the first willing fair royalty, receiving the first willing fair royalty as a premium for an insurance policy, the insurance policy indemnifies damages based on infringement by the product of at least the first patent.

10. The method of claim 9, wherein the infringement relevancy group includes at least a second patent, the second patent having at least one claim covering the product, the method further comprising:
determining a second willing fair royalty for the second patent.

11. The method of claim 10, wherein the second willing fair royalty is the same as the first willing fair royalty.

12. The method of claim 10, further comprising:
offering the second willing fair royalty to a second owner of the second patent.

13. The method of claim 12, wherein the insurance policy has a policy coverage limit, and wherein the policy coverage limit is based at least in part on whether the second owner accepts the second willing fair royalty.

14. The method of claim 10, further comprising:
receiving a total fair royalty from a manufacturer of a product, the total fair royalty including at least the first willing fair royalty and the second willing fair royalty.

15. The method of claim 9, wherein the insurance policy indemnifies damages based on infringement by the product of a second patent, the second patent is not in the infringement relevancy group.

16. The method of claim 9, further comprising:
assessing the validity of the first patent.

17. A method for managing exposure to damages liability for patent infringement by a product, comprising:
performing an economic analysis to calculate a total maximum royalty for a product, wherein the total maximum royalty is based on an estimated cost and an estimated sale price of the product; and
receiving a premium for an insurance policy from a first entity, wherein the premium of the insurance policy is determined based in part on the calculated total maximum royalty; and
if a first portion of the premium is not paid in claims at the termination of the insurance policy, returning a second portion of the premium to the first entity.

18. The method of claim 17, further comprising:
determining a fair maximum potential liability based on the total maximum royalty and an amount of royalty attributable to an intellectual property right assigned to the first entity.

19. The method of claim 18, wherein the premium of the insurance policy is based in part on the determined fair maximum potential liability.

20. The method of claim 17, wherein the first portion of the premium is the same as the second portion of the premium.

21. The method of claim 17, wherein the second portion of the premium is returned to the first entity if the first portion of the premium is greater than an amount of fees due to an insurer.

22. The method of claim 17, further comprising:
indemnifying the first entity against damages based on infringement of a first patent by the product.

23. A system, comprising:
a computer-readable storage medium that stores instructions executable by at least one processing device, wherein the storage medium includes,
instructions for performing a patent search to identify an infringement relevancy group, wherein the infringement relevancy group includes at least a first patent, the first patent having at least one claim covering a product,
instructions for determining a total fair royalty for the product,
instructions for allocating the total fair royalty among the patents in the infringement relevancy group to determine a willing fair royalty for the first patent; and
a user interface adapted to display the determined willing fair royalty from the processing device after the processing device has executed at least one of the instructions.
